(19) United States
(12) Patent Application Publication
(10) Pub. No.: US 2001/0054339 A1
(43) Pub. Date: Dec. 27, 2001

(54) Perforation device

(76) Inventor: Risto Pekka Antero Nokelainen, Kirkkonummi (FI)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/935,917

(22) Filed: Aug. 23, 2001

Related U.S. Application Data
(63) Continuation of application No. 09/029,549, filed on Mar. 6, 1998.

(30) Foreign Application Priority Data
Sep. 5, 1996 (FI) PCT/FI96/00474

(51) Int. Cl. B26D 1/00

(52) U.S. Cl. 83/13; 83/660

(57) ABSTRACT

A device and method for selectively perforating sheets of paper that are moving successively through a perforation device, where the perforation along a direction of the movement. A perforation device performs the perforation. The perforation device includes a perforating tool having a perforating position in which the paper is perforated and a neutral position in which the paper is not perforated. The perforation device further includes a control unit to control the perforating tool by optionally setting the perforating tool in either a perforating position or neutral position. The sheets are run successively through the perforating device, and each selected sheet is perforated in its direction of movement. The perforating tool receives a control signal to set the perforating position if a sheet to be perforated enters the perforating device, and the sheet is perforated along the direction of movement in accordance with the signal.

### RELATED APPLICATION

This is a continuation application which claims priority under 35 U.S.C. §120 to commonly-owned, co-pending U.S. patent application Ser. No. 09/029,549 entitled, “PERFORATION DEVICE”, filed Mar. 6, 1998, which is hereby incorporated by reference in its entirety.

### BACKGROUND OF THE INVENTION

The invention relates to a perforator for perforating a moving paper in its direction of movement. The invention can for instance be implemented in the perforation of paper sheets printed out from a printer.

### DESCRIPTION OF THE RELATED PRIOR ART

Letter sheets often have a section defined with perforation, which the receiver can tear off. The perforated parts are frequently forms such as bank transfer slips or reply forms. Such letters are typically printed out in large series and inserted in mailing envelopes by mechanical means.

Letters of the kind above can be printed out on preperforated paper. In that case, different paper qualities will be required if unperforated sheets are desired. In addition, the perforation will always be in the same place of the sheet, and thus there will be limitations on the layout of the printout. If a perforated paper web is fed from a reel to be printed out, each sheet will have a perforation, whether desired or not.

There are perforators connected to printers, which perforate paper in the direction of movement. These also have the drawback of providing each sheet with a perforation. Patent specification EP A 658406 discloses such a device, which allows the length of the perforation and its position on the sheet to be regulated in advance. Yet this device will also provide each sheet with similar perforation.

### SUMMARY OF THE INVENTION

A perforator as defined in claim 1 has now been invented. The remaining claims describe a number of preferred embodiments of the invention.

The essential feature of the invention is that perforation in the direction of movement can be performed under control, limited to a specific distance, and on selected sheets. Moreover, the perforation may be given the desired length on each sheet.

The device has a perforating tool, which can be controllably set in perforating position or neutral position, in which perforation is not performed. In practical operation, this can be done by making the distance of the perforating tool to the moving paper variable, so that the tool either touches the paper, producing a perforation, or is at a distance from the paper, so that no perforation is produced.

In the preferred embodiment the device comprises a perforating tool that is movable relative to the paper. The tool can be moved in any suitable manner, pneumatically for instance.

The tool control apparatus may be preprogrammed to receive a signal from the printer output data or by reading a code on the paper by means of a reader.

The transverse position of the perforating tool is preferably adjustable. This allows the perforation to be positioned in the desired place in each case.

There may also be several, for instance two perforating tools. This allows a corresponding number of perforations, e.g. two perforations, to be performed simultaneously.

The perforation may be performed after or before printing. The device may be firmly connected to the printer or separate from it.

The arrangement in accordance with the invention allows the same paper to be consistently used in the printer, while perforation is nevertheless performed selectively on the desired sheets alone. This yields a particular advantage when perforation is needed only on specific pages of printout letters with many pages.

The device in accordance with the invention enables high printout speeds to be obtained.

### BRIEF DESCRIPTION OF THE DRAWINGS

The accompanying drawings pertain to the special description of the invention. In the drawings

FIG. 1 is a schematic view of the perforation process;

FIG. 2 shows a printout unit to which a perforation unit has been connected;

FIG. 3 illustrates selective perforation of a letter with many pages; and

FIG. 4 is a front view of the perforation unit.

### DETAILED DESCRIPTION OF THE INVENTION

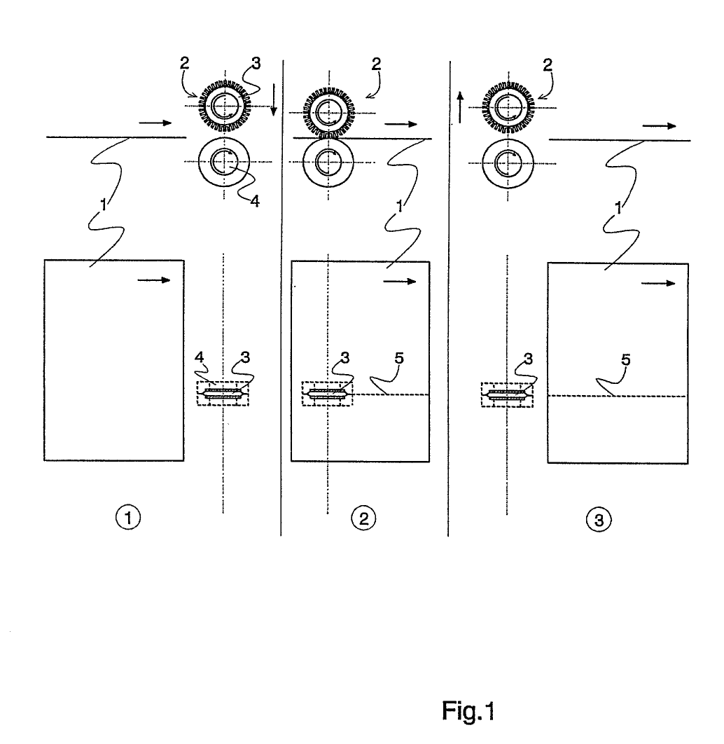

In the configuration in FIG. 1, paper sheets 1 pass through perforation unit 2, where the paper is perforated in the travel direction if needed. The perforation unit includes a perforating disc 3 rotating in the direction of movement of the paper and an opposing roll 4, the paper running between these two. The perforating disc is vertically movable such that it can be brought into contact with the paper, producing perforation, or kept apart from the paper, so that no perforation is produced.

In the first step in FIG. 1, paper 1 is about to enter perforation unit 2. If the paper is to be perforated, the actuator of the perforation unit is given a signal to lower perforation disc 3 for the time the paper passes in front of the disc (step 2). Thus a perforation 5 in the direction of movement is produced on the paper. When the paper has passed by the disc, the disc will automatically rise to its upper position (step 3). If no perforation is desired, the perforation unit is not given any signal the paper passing then through the unit with the perforation disc constantly at a distance from the paper.

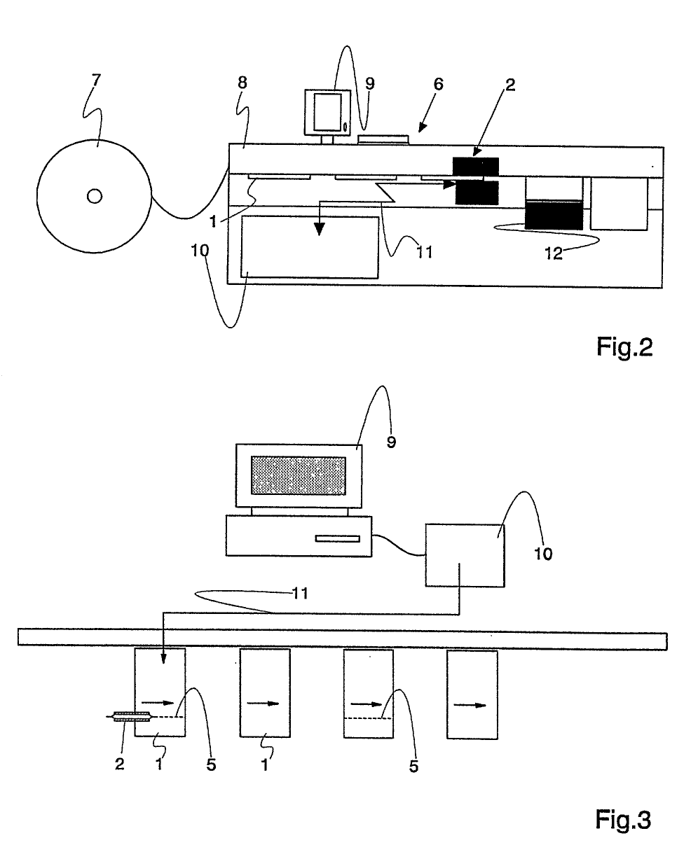

FIG. 2 illustrates a configuration where perforating unit 2 is placed in printout unit 6. In this, paper is taken from reel 7, is cut into sheets I and the desired message is printed on the sheets with printer 8. The printout is controlled by means of computer 9 and control unit 10. If perforation is desired on the sheet, a signal 11 is emitted from the control unit to the perforation unit. The perforated sheets are stacked in a pile 12 and transferred to a mailing machine, for instance.

The printout unit in FIG. 2 can also be used to prepare serial letters comprising several sheets 1. Thanks to the selective perforation, the desired perforation is obtained just on the intended pages. FIG. 3 is a schematic view of a process where perforation 5 is performed on the second and fourth page of a four-page letter.

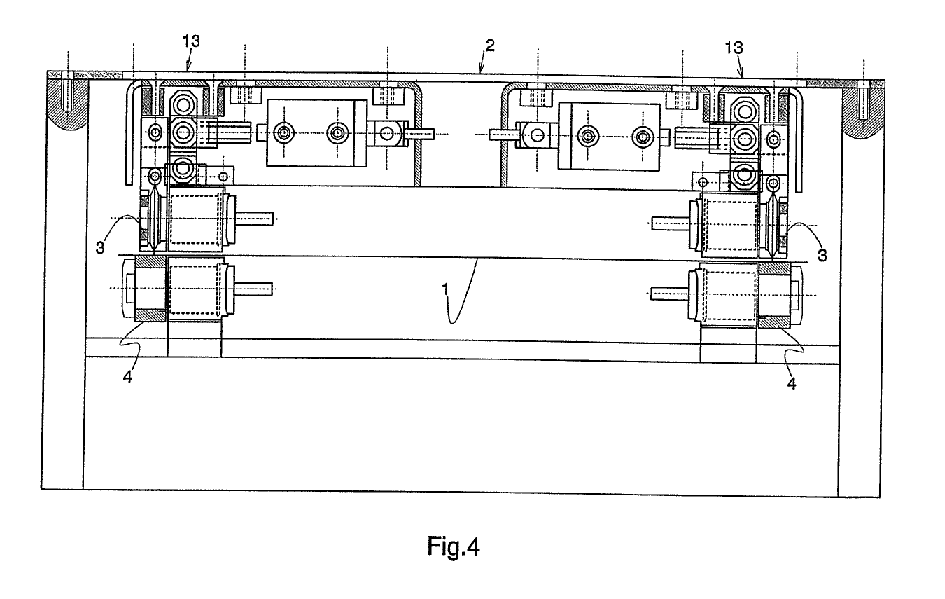

FIG. 4 is a front view of a perforation unit 2. It includes two rotatable perforating discs 3 with opposing rolls 4. The pairs of disc/roll can be moved in the transverse direction. Each of the perforating discs is connected with an independently controlled, pneumatically operating shifting apparatus 13, by means of which the disc can be lowered into perforating position, if desired. In normal operation, the disc is in upper position. If the sheet 1 passing underneath is to be perforated, the shifting apparatus is given a pulse, and then the disc is pressed against the sheet over the desired period such that a perforation with the desired length is produced. Such a perforation unit has a capacity of over 30,000 perforated sheets per hour.

The opposing roll 4 of perforation disc 3 is flat i.e. it has no groove matching the disc. In this manner, there will be no relief on the paper, which could hamper any further handling of the paper.

1. A perforator for selectively perforating sheets of paper that are moving successively through the perforator, the perforation being along a direction of the movement, the perforator comprising:
a first perforating tool past which one or more sheets of paper move successively, the first perforating tool having a perforating position to perforate paper passing the perforating tool, and having a neutral position to refrain from perforating paper passing the perforating tool, and having an input for receiving a first control signal; and
an electronic control apparatus having an input to receive a second control signal and an output connected to the input of the first perforating tool, wherein, for each sheet of paper that passes the first perforating device, the second control signal corresponds to the sheet, and wherein, the electronic control apparatus is configured such that, for each sheet of paper that passes the first perforating device, if perforation is desired for the sheet based on the second control signal, the electronic control apparatus emits a signal from the output of the electronic control apparatus to the input of the first perforating tool to place the first perforating tool in the perforating position, and if perforation is not desired for the page based on the second control signal, the electronic control apparatus does not emit a signal to the first perforating tool.

2. A perforator as claimed in claim 1, wherein the electronic control apparatus is operative, for each sheet of paper that passes the first perforating device, to set a distance of the first perforating tool from the sheet such that, in the perforating position, the first perforating tool touches the sheet, and in the neutral position, the first perforating tool is kept apart from the sheet.

3. A perforator as claimed in claim 1, wherein the first perforating tool is movable relative to the paper.

4. A perforator as claimed in any of claims 1 to 3, in which a position of the first perforating tool (3) is variable in the traverse direction.

5. A perforator as claimed in any of claims 1 to 3, further comprising:
at least a second perforating tool.

6. A perforator as claimed in any of claims 1 to 3, wherein the first perforating tool is a rotating disc having a perforating edge.

7. A perforator as claimed in claim 6, further comprising:
an opposing roll that is situated in an opposed position to the first perforating tool.

8. A perforator as claimed in claim 7, wherein the opposing roll has a flat surface.

9. A perforator as claimed in any of the claims 1 to 3, wherein the first perforator receives each sheet after a printing of the sheet.

10. A perforator as claimed in any of the claims 1 to 3, wherein the perforator is connected to a printer.

11. A method of selectively perforating sheets of paper that are moving successively through a perforation device, the perforation being along a direction of the movement, the perforation device including a perforating tool having a perforating position in which a sheet of paper is perforated and a neutral position in which a sheet of paper is not perforated, the device further including a control unit to control the perforating tool, the method comprising acts of:
successively receiving the moving sheets at the perforating device;
for each received sheet, receiving at the control unit a first control signal corresponding to the received sheet;
sending a second control signal from the control unit to the perforating tool to set the perforating tool into the perforating position if, based on the first control signal, a received sheet to be perforated enters the perforating device; and perforating the received sheet along the direction of movement in accordance with the second control signal to produce a perforated sheet.

12. A method according to claim 11, wherein the act of receiving includes:
receiving the signal from a printer output data.

13. A method according to claim 11, further comprising an act of:
transferring the sheets to a mailing machine after the act of perforating.

14. A method of selectively perforating sheets of paper moving successively through a perforating device, the perforating device including a first perforating tool for perforating sheets of paper and a control unit for controlling the perforating tool, wherein the first perforating tool perforates the paper along a direction of the movement of the sheets, the method comprising acts of:
successively receiving a plurality of sheets of paper as input to the perforating device; and
positioning the first perforating tool in either a perforating position to perforate paper or a neutral position to allow paper to pass unperforated, including:
for at least a first sheet, receiving at the control unit a first control signal corresponding to the first sheet;
sending, based on the first control signal, a second control signal from the control unit to the first perforating tool to cause the first perforating tool to assume the perforating position; and
in response to receiving the second control signal from the control unit, actuating the first perforating tool to assume the perforating position while the first sheet passes.

15. The method of claim 14, wherein the act of positioning includes:
maintaining the first perforating tool in the neutral position if no control signal is received at the first perforation tool.

16. The method of claim 14, further comprising an act of:
controlling the control unit with a second signal received from a data signal output of a printer.

17. The method of claim 14, further comprising an act of:
controlling the control unit with a second signal received from a reader that reads codes from the sheets of paper.

18. The method of claim 14, wherein the perforation unit includes at least a second perforating tool that selectively perforates the selected sheets of paper such that selected sheets receive at least two perforations.

19. The method of claim 14, wherein the perforation unit includes at least a second perforating tool, the method further comprising an act of:
selectively positioning the second perforation tool in the perforating position contemporaneously with positioning the first perforation tool in the perforating position such that one or more selected sheets receive at least two perforations.

20. The method according to claim 12, further comprising an act of:
transferring the sheets to a mailing machine after the act of perforating.

21. The method of claim 20, wherein the act of receiving the signal includes:
receiving the signal from printer output data.

22. The method of claim 20, wherein the act of receiving the signal includes:
reading a code in the sheets with a reader.

23. The method of claim 11, wherein the act of receiving the signal includes:
reading a code in the sheets with a reader.

24. The perforator of claim 1, wherein the control apparatus is operative to set the first perforating tool in the perforating position for different durations such that perforations of different lengths are produced for two or more of the perforated sheets.

25. The method of claim 11, wherein:
the first control signal received by the control unit indicates that the perforating tool is to be set into the perforating position for a first duration;
the act of perforating includes perforating the sheet for a first length along the direction of movement in accordance with the first duration indicated by the signal; and
two or more of the perforated sheets have perforations of different lengths.

26. The method of claim 14, wherein:
the first control signal indicates that the first perforation tool is to assume the perforating position for a first duration;
the act of actuating includes:
actuating the first perforation tool to assume the perforating position for the first duration; and
returning the first perforation tool to the neutral position after the first duration has elapsed to produce a perforation of a desired length; and
the desired length of the perforation is different for two or more of the perforated sheets.

27. A system for selectively perforating sheets of paper moving successively through a perforating device, the perforating device including a first perforating tool for perforating paper and a control unit for controlling the perforating tool, wherein the first perforating tool perforates the paper along a direction of the movement of the sheets, the system comprising:
means for successively receiving a plurality of sheets of paper as input to the perforating device; and
means for positioning the first perforating tool in either a perforating position to perforate paper or a neutral position to allow paper to pass unperforated, including:
means for receiving at the control unit, for at least a first sheet, a first control signal corresponding to the first sheet;
means for sending, based on the first control signal, a second control signal from the control unit to the first perforating tool, to cause the first perforating tool to assume the perforating position; and
means for actuating, in response to receiving the control signal from the control unit, the first perforating tool to assume the perforating position while the first sheet passes.

28. The system of claim 27, wherein, if no second control signal is received at the first perforation tool, the first perforating tool is maintained in the neutral position.

29. The system of claim 27, wherein the control unit is controlled by a second signal received from a data signal output of a printer.

30. The system of claim 27, wherein the control unit is controlled by a second signal received from a reader that reads codes from the sheets of paper.

31. The system of claim 27, wherein each sheet has been printed before such sheet passes the perforating tool.

32. The system of claim 27, wherein the perforation unit includes at least a second perforating tool that selectively perforates the selected sheets of paper.

33. The system of claim 27, wherein:
the first control signal indicates that the first perforation tool is to assume the perforating position for a first duration;
the means for actuating includes:
means for actuating the first perforation tool to assume the perforating position for the first duration and returning the first perforation tool to the neutral position after the first duration has elapsed to produce a perforation of a desired length; and
the desired length of the perforation is different for two or more of the perforated sheets.
